(19) United States
(12) Patent Application Publication
(10) Pub. No.: US 2004/0082388 A1
(43) Pub. Date: Apr. 29, 2004

(54) Apparatus and method for incorporation of external digital or analog information in computer and console gaming environments

(76) Inventors: Burc A. Simsek, Houston, TX (US); Trudy D. Stetzler, Houston, TX (US)

Correspondence Address: TEXAS INSTRUMENTS INCORPORATED, P O BOX 655474, M/S 3999, DALLAS, TX, 75265

(21) Appl. No.: 10/278,954

(22) Filed: Oct. 23, 2002

(51) Int. Cl. A63F 13/00

(52) U.S. Cl. 463/43

(57) ABSTRACT

A game console/computer as coupled thereto an external interface unit. The external interface unit permits information from a selected channel/address/station to be entered into the processor controlling the gaming environment and incorporated in the gaming environment. The incorporation of the information in the gaming environment can take the form, for example, of background audio material, audio material selectable from an image on the display, or image data incorporated in the display. For example, the information incorporated in the display can take the form of advertisements display on the image of a billboard. Using weather information content or traffic information content parameters of display portion of the game can be modified to provide a more interesting game environment.

### BACKGROUND OF THE INVENTION

1. Field of the Invention

This invention relates generally to improvements in the gaming environment and, more particularly, to the incorporation of the externally generated information in the gaming environment.

2. Background of the Invention

The gaming environment of digital games has continued to improve. The game images have become increasingly realistic. The games themselves have become more complex, frequently permitting long periods of interaction between the user and the program.

Similarly, the audio portion of the game environment has changed from simple tone-based sample playback to fully CD-like, compressed audio material. Today, games with simulated radios, complete with knobs, buttons, and display units, play pre-recorded compressed audio files from the game source CDs. These games permit the player to experience a heightened degree of realism in the gaming environment such as interactions with the vehicle radio during a racing game. Also available are games that permit the user to insert their own CDs in a console during the game permitting the user to listen to their favorite audio tracks. The capability to include CD-quality audio tracks in the games have incurred costs in licensing or in creating the audio material used in the games. In some instances, game creators use lower cost versions of popular songs to reduce licensing costs. However, in view of the frequently long periods of time required to play the games, the novelty of listening to a limited selection of songs or audio segments can wear off quickly.

In order to enhance the experience of the gaming environment, a wider selection of audio and data materials should be available to the gamer. This additional material should be available on sources available to the simulation program, but not part of the program. Furthermore, the incorporation of externally available display materials in the game can increase the flexibility and richness of the environment.

A need has therefore been felt for an apparatus and an associated method having the feature that external material can be incorporated into a gaming environment. It is another feature of the apparatus and associated method to permit the gaming environment to provide an audio output that is provided by external information sources. It is still another feature of the apparatus and associated method to permit the user to select the audio material output for incorporation in the game. It is yet another feature of the apparatus and associated method to incorporate external display materials in the display provided by a gaming environment. It is a further feature of the apparatus and associated method to control external source information included in the game. It is yet a further feature of the apparatus and associated method to acquire external data and to include the external data in the gaming environment. It is still a further feature of the present invention to permit external sources to control aspects of the game simulation.

### SUMMARY OF THE INVENTION

The aforementioned and other features are accomplished, according to the present invention, by coupling to the game console/computer an interface unit for receiving channels/addresses/stations having material appropriate for incorporation in the gaming environment. Either the game program or the user, acting through the game program, can select the channel/address/station for incorporation in the gaming environment. For example, the interface device can be a digital radio. When the programming received by the digital radio has the appropriate header information, the appropriate background audio content can be selected by the user and played with the game. The audio content can be selected by the program itself or can be selected by interaction of the user with the program through the user interface. The audio material can be selected by providing a search algorithm for a particular audio content such a pop, country western, rock, etc. Similarly, a search can be provided for other information, such as weather, that can be incorporated in the game. The parameters under which the game is played can mimic the actual local conditions, such as weather or traffic, provided by the radio. Or, display material can be provided by an external source and incorporated in the gaming environment display. The interface device can provide an interface with the Internet to provide a more diverse range of materials to incorporate in the game. The game program can therefore interface with selected Internet addresses to download materials for incorporation in the game display.

Other features and advantages of present invention will be more clearly understood upon reading of the following description and the accompanying drawings and the claims.

### BRIEF DESCRIPTION OF THE DRAWINGS

FIG. 1 is a block diagram of the principal components for incorporating external data in a gaming environment according to the present invention.

FIG. 2 is a block diagram of game apparatus and associated apparatus according to the present invention.

FIG. 3A, FIG. 3B, and FIG. 3C illustrates configurations of the PC/game console and the radio, while FIG. 3D provides a conceptual illustration of the software interfaces between the game program and the signals interacting with the game program.

FIG. 2A, FIG. 2B, and FIG. 2C illustrate exemplary examples of the incorporation of external data into the gaming environment according to the present inventions.

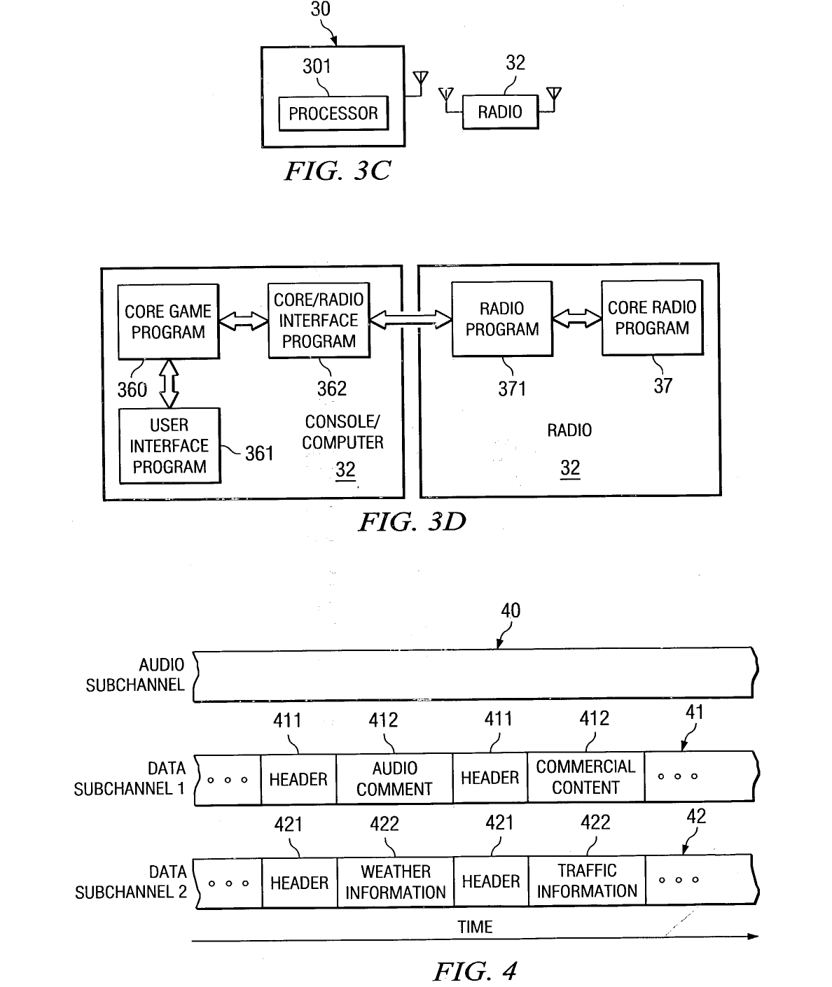

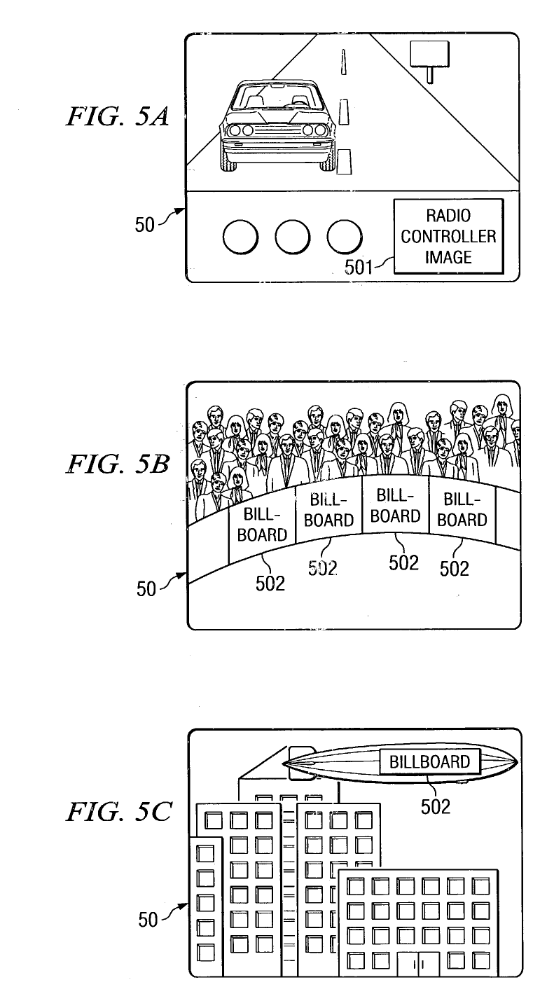

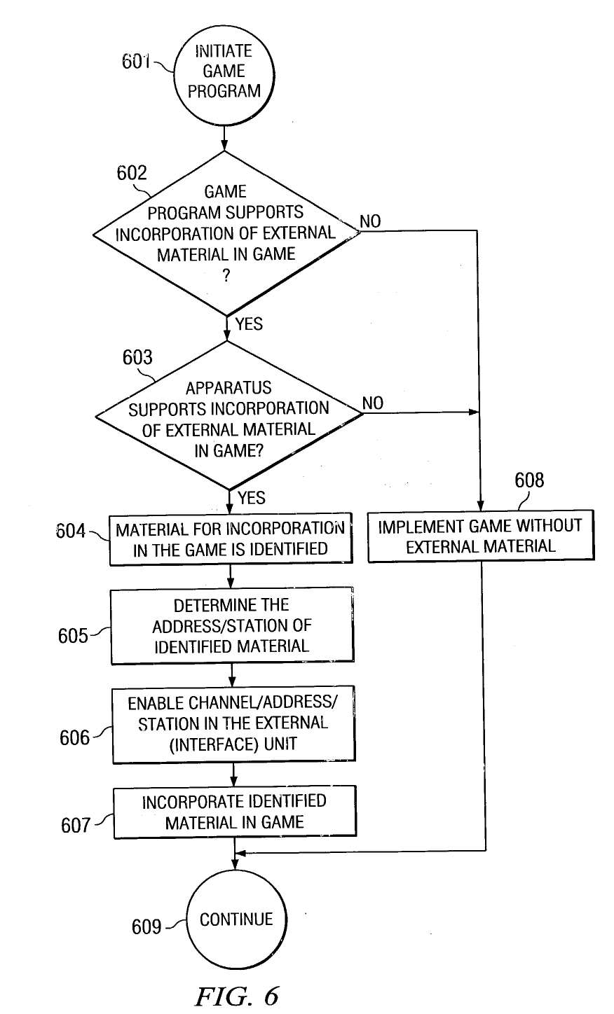

FIG. 3 illustrates the process by which external material is incorporated in the gaming environment according to the present invention.

### DESCRIPTION OF THE PREFERRED EMBODIMENT

1. Detailed Description of the Figures

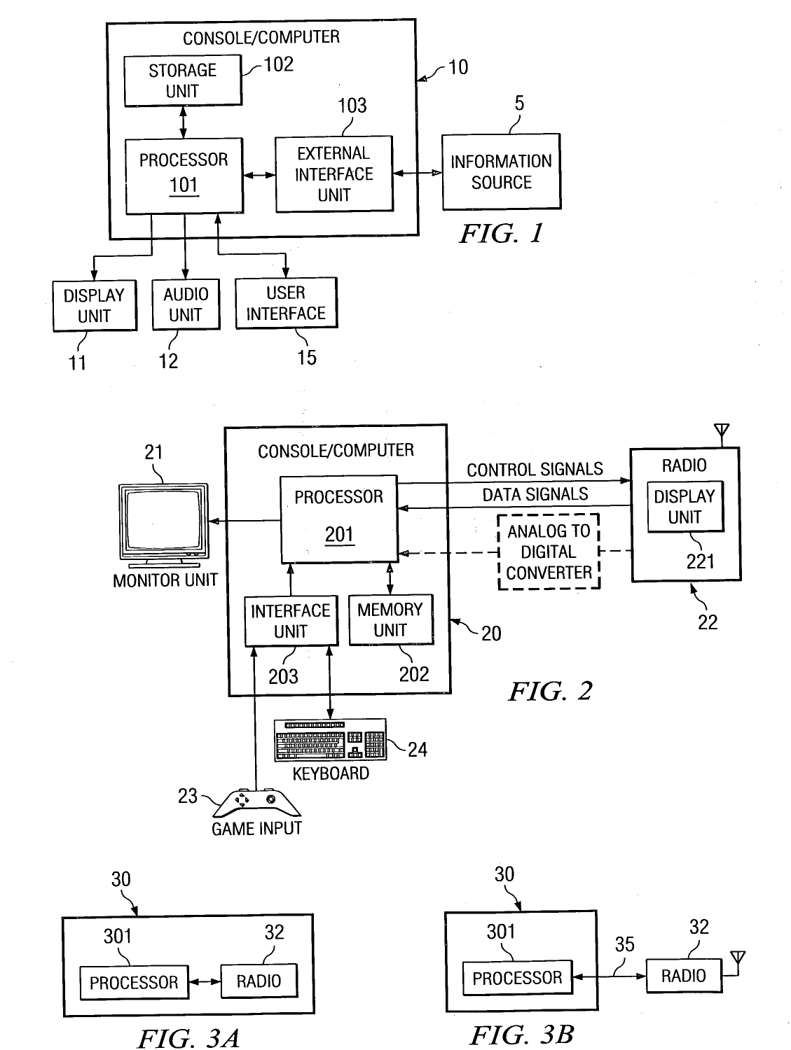

Referring to FIG. 1, the components for incorporating external data into a gaming environment according to the present invention are shown. Console/computer 10 includes a processor 101 that is coupled to storage unit 102. The storage unit 102 stores at least a portion of the simulation program that forms the basis for generating the gaming environment. The processor 101 receives signals from and sends signal to the user interface 15. The user interface 15 permits the user to interact with the program and to control certain aspects of the progress of the game. The display unit 11 provides the output of the game and typically displays the current status of the game and provides the user with options that can be exercised through the user interface 15. The processor 101 can also apply signals to the audio unit 12. The processor 101 is also coupled to external interface unit 103. External interface unit 103 receives signals from the external information source 5. The program, or the user acting through the program, can select a channel/address/station with a predefined information content or can select a specific channel/address/station.

Referring to FIG. 2, an embodiment of the invention capable of advantageously using the present invention is shown. A console/computer 20 applies signals to a monitor unit 21. The monitor unit 21 can provide a display output as well as an audio output. The console/computer 20 receives control signals from a game input device such as a joystick 23 and/or a keyboard 24. The input device permits the user to interact with the game program. The console/computer 20 receives signals from a radio 22. If the radio 22 is a digital radio, then the signals therefrom can be applied directly to the console/computer 20. If the radio 22 is an analog radio, then an analog to digital converter 25 is necessary to provide signals that can be processed by the console/computer 20. In some embodiments of the present invention, the console/computer 20 can apply control signals to the radio, e.g., in order to tune the radio receiver to a selected frequency or to provide a search for predetermined programming. The console/computer 20 includes a memory unit 202 in which the game program is stored, a processor 201 exchanging signals with the memory unit 202 for implementing the game, and an interface unit 203 for receiving control signals from the user for interaction with the processor 201. Based on the game program, the user inputs, and the input from the radio 22, the processor 201 generates signals that control the visual display and the audio output of the monitor 21. The output of the monitor 21 determines the input from the user.

Referring to FIG. 3A, FIG. 3B, and FIG. 3C, various configurations of the radio 32 and the console/computer 30 are shown. In FIG. 3A, the radio 32 is incorporated in and is a part of the console/computer 30. In FIG. 3B, the radio 32 and the console/computer 30 are coupled by an external bus 35 through which signals can be exchanged. In FIG. 3C, the radio 32 and the console/computer 30 are coupled in a wireless configuration in which any one of the standard or non-standard protocols can be used. In each configuration, the radio 32 is ultimately coupled to the processor 301 of the PC/game console 30. As will be clear, when the radio 32 is an analog radio, then an analog-to-digital conversion is understood to convert the analog signals to signals that the processor 301 can manipulate. Referring to FIG. 3D, a further aspect of the interaction with the console/computer 30 and the radio 32 is shown. The console/computer 30 operates under the control of a core game program 36. A user interface program 361 permits the user input signals to interact with the core game program 36. Similarly, a radio interface program 362 permits the signals from the radio 32 to interact with the core game program 37. Similarly, the (digital) radio 32 operates under the control of a core radio program 37. The radio 32 includes a radio output interface program 361 for providing a standardized interface with other devices, i.e., the console/computer 30. The separation of the core programs and the interface programs facilitates changes and updates. For example, a new user input device with application of a different signal set can requires only changes to the user interface program 351 and not to the core game program 35. Similarly, changes to the core programs can be made without affecting the coupled interface program.

Referring to FIG. 4, a symbolic representation of the information received by a digital radio for each broadcast channel is shown. According to one embodiment, each channel can include an audio subchannel 40 and at least one data subchannel 41 and 42. The audio subchannel 40 typically provides a continuous audio output. The data subchannels 41 and 42 can include information that can be displayed on a radio display unit 221. The data in the subchannel is divided into packets of data. Each packet can include a header portion 411 and 421 that identifies the material transmitted with the packet and a data portion 412 and 422 that contains the informational content. Typical content for the data portions 412 and 422 are comments on the audio subchannel, commercials, weather information, traffic information, etc. Using the headers 411 and 421, the user of the radio 32 can select the information to be displayed on radio display 321. For the purposes of the present invention, not only can the audio subchannel be applied to the processor and ultimately to a monitor unit, but the game program and/or the user access a preselected packet or packets and have the information content transferred to the processor 301.

Referring to FIG. 5A, FIG. 5B, and FIG. 5C, specific embodiments of the incorporation of the externally-derived information in a gaming environment is illustrated. In FIG. 5A, a vehicle simulation is illustrated wherein the user has displayed on the game display the view as seen through a simulated windshield along with the vehicle dashboard. Included on the vehicle dashboard is the image of a radio control panel 501. A cursor controlled by the user interface can be used to manipulate the radio control panel 501, thereby allowing the user to select the audio channel material applied to the monitor unit.

Referring to FIG. 5B and FIG. 5C, the incorporation of a visual display in the gaming environment is shown. In these examples, the program itself would typically determine which channel/address/station is to be accessed. (This embodiment can allow the game creator to receive revenue by providing optional advertising material in the simulation.) In FIG. 5B, a billboard 502 is illustrated as part of the display gaming environment. The material displayed can be from the simulation program itself in the default mode. A slightly more elegant visual display is shown in FIG. 5C wherein the image of vehicle, such as the illustrated blimp 503, can have a advertisement that can be selected by the game program, i.e., when an appropriate packet has information available therein.

Further examples of application to the game environment are the following. For an athletic contest, the game program, using the subchannel headers, can access the local weather. Once the packet is accessed, the processor can identify the weather conditions by analysis of the information and the display of the monitor unit, in conjunction with the game program, can be altered appropriately. Thus, athletic contests, such a football or soccer, can be played according to local weather conditions, i.e., in rainy conditions or in snowy conditions. Travel advisories are another information provided by the digital radio. Therefore, in game situations or simulations where traffic conditions determine parameters of the program, these conditions can be determined by accessing the digital radio data subchannels through the console/computer.

Referring to FIG. 6, the process by which external material is incorporated in the gaming environment is illustrated. In step 601, the game program is initiated. In step 602, a determination is made whether the game program supports the incorporation of external material in the game context. When the game program does support the incorporation of external material in the game, then in step 603, a determination is made whether the apparatus on which the game program is executing supports the incorporation of external material in the game context. When the apparatus supports the incorporation of external material in the game program, in step 604, the material for incorporation in the gaming environment is identified. The identification may be included in the game program itself, or may be provided by the user through interaction with the game program. The processor then determines the channel/address/station wherein the identified material can be found in step 605. In step 606, the processor enables the appropriate channel/address/station in the external interface unit. In step 607, the processor manipulates the material received from the external interface unit and incorporates the material in the game program. The game execution continues in step 609. When in step 602, the game program does not support the incorporation of the external material in the game, or when in step 603 the apparatus does not support the incorporation of external material in the game, then is step 608, the game program is executed without the incorporation of the external material and the program execution is continued in step 609.

2. Operation of the Preferred Embodiment

The purpose of the present invention is to provide a more interesting and/or a more realistic gaming environment. The present invention permits the incorporation of user-selectable information into a gaming environment by means of coupling to external data sources. Exemplary of the components used to acquire external information are Internet connections and analog and digital radio. These components share the feature that particular information streams can be accessed, i.e., by address, channel selection, tuning, etc.

The materials that can be incorporated into the gaming environment can include background music. The ability to select an appropriate address or program can eliminate the reliance on a relatively limited audio track included with the game simulation program. Furthermore, in programs wherein the user has a vehicle dashboard displayed, the dashboard can include, for instance, a radio control panel thereby permitting the user to manipulate the displayed controls to control the accessed information (e.g. radio station) currently being played on the audio unit. When the game program is set in a particular locality, the accessed information can be made consistent with the locality of the game environment, e.g. a radio station that is broadcast in the locality of the gaming environment.

A more sophisticated use of the present invention would be to have the accessed information stream provide a visual display for incorporation into the program. For example, an area that is included as a billboard could have a default image displayed thereon. However, when the external information is available, the default advertising display can be replaced by a different display. Such a different display could be incorporated in the program in some more interesting manner, such as being displayed on the side of a blimp image or being displayed on a banner image being pulled by an airplane image.

The external interface unit can either be an independent component or can be combined with the processor. When the external interface unit is combined with the processor, the processing power of processor is available to identify and select information available from the information source.

With particular reference to the digital radio, the use of headers in the data stream transmission is becoming increasingly prevalent. These headers include fields that describe the content of the accompanying program material. For example, the type of music being broadcast can be identified. In this manner, the processor, by analyzing the header information, can respond to requests for specific types of program material. In the future, headers will be provided with more detailed information permitting even more customization of the resulting program.

The foregoing discussion has focused on the digital radio with the plurality of subchannels available for providing information content. Modem technology is permitting analog radios to be provided with information subchannels. In this situation, the analog radio can be used to implement the aspects of the present invention that require the acquisition of a portion of the information content of the station/channel.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. Apparatus for playing digital games, the apparatus comprising:
a game console/computer, the game console/computer including:
a display unit;
an audio unit;
a user interface;
a processor responsive to the user interface and a simulation program, the processor providing signals to the display unit; and
an external signal interface coupled to the processor for providing external materials for incorporation in the game.

2. Apparatus as recited in claim 1 wherein the external signal interface is a radio.

3. Apparatus as recited in claim 2 wherein the signals from the radio are incorporated into the simulation program.

4. Apparatus as recited in claim 3 wherein the signals from the radio provide a background audio track for the game.

5. Apparatus as recited in claim 3 wherein the user can select the audio program for incorporation in the digital game.

6. Apparatus as recited in claim 5 wherein the display from the simulation program includes a radio control panel, the user interface permitting the user to control the audio from the external signal interface by simulated manipulation of the radio control panel.

7. Apparatus as recited in claim 1 wherein the external signal interface couples the processor to the interface.

8. A method for incorporating external information in a gaming environment, the method comprising:
coupling an interface unit to the game console/computer, the interface receiving information from an external source, the interface unit applying signals to the processor of the game console/computer; and
in the game program code, including the functionality that permits the user to select the channel/address/station being applied to the processor; and
in the game program code, including the functionality to incorporate information form the selected channel/address/station in the gaming environment.

9. The method as recited in claim 8 wherein the selected channel/address/station provides background audio material in the gaming environment.

10. The method as recited in claim 8 wherein the selected channel/address/station provides audio material controlled by user interaction with an image on a game display.

11. The method as recited in claim 8 wherein the external interface unit can be selected form the group consisting of an analog radio receiver, a digital radio receiver, and an Internet interface unit.

12. A gaming environment, the gaming environment comprising:
a processor;
a game program for controlling the operation of the gaming environment;
an interface unit, the interface unit permitting a user to interact with the program;
an external interface unit for receiving information from a selectable channel/address/station, wherein selected information is incorporated in the gaming environment.

13. The gaming environment as recited in claim 12 wherein the selected information is selected audio information.

14. The gaming environment as recited in claim 13 wherein the selectable channel/address/station is selected by a user interaction with a gaming environment display.

15. The gaming environment as recited in claim 12 wherein the selected information is selected data display information.

16. The gaming environment as recited in claim 15, wherein the selected display information is included in the display generated by the processor and the game program.
